(19) United States
(12) Patent Application Publication
(10) Pub. No.: US 2007/0166356 A1
(43) Pub. Date: Jul. 19, 2007

(54) Food supplement for animals, comprising an olfactory additive

(75) Inventors: Pierre-Andre Geraert, Rochecorbon (FR); Goetz Gotterbarm, Saint Cloud (FR); Claude Annonier, Noyant-la-Gravoyere (FR); Yves Mercier, Clermont-Ferrand (FR)

Correspondence Address: OLIFF & BERRIDGE, PLC, P.O. BOX 19928, ALEXANDRIA, VA, 22320, US

(73) Assignee: ADISSEO IRELAND LIMITED, DUBLIN 1 (IE)

(21) Appl. No.: 11/578,240

(22) PCT Filed: Jun. 7, 2005
(86) PCT No.: PCT/FR05/01395

§ 371 Date: Feb. 27, 2007

(30) Foreign Application Priority Data
Jun. 8, 2004 (FR) 0406177

(51) Int. Cl. A23K 1/165; A23K 1/17

(52) U.S. Cl. 424/442; 426/635

(57) ABSTRACT

The present invention generally relates to the feeding of animals, and in particular to the complementation of this feeding with an active compound, i.e., an amino acid, or an amino acid derivative, for example methionine. The present invention in particular relates to a feed complement for animals comprising at least one amino acid or amino acid derivative and at least one olfactory additive.

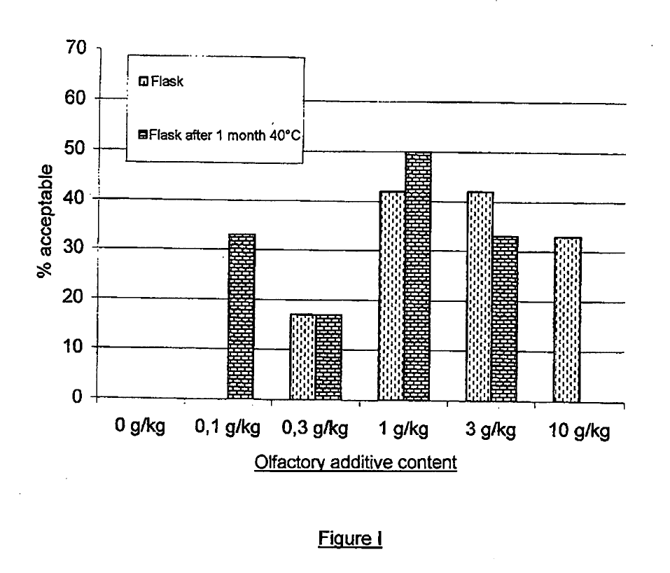

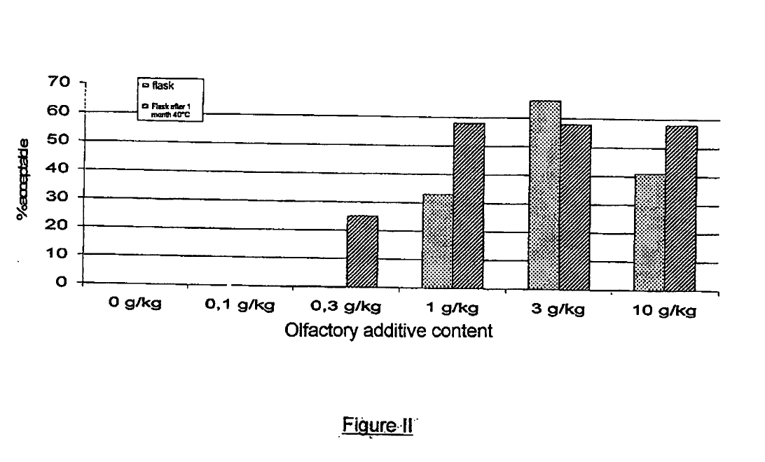

The present invention generally relates to the feeding of animals and in particular to the complementation of this feeding with an active compound, i.e. an amino acid or an amino acid derivative, for example methionine. The present invention in particular relates to a feed complement for animals comprising at least one amino acid or amino acid derivative and at least one olfactory additive.

Feed complements for animals are products intended to be ingested, as a complement to ordinary feeding, in order to compensate for insufficiency in daily intakes of certain compounds. For instance, it is generally known how to complement livestock feed rations with active compounds, in order to increase zoo technical performances of raised animals.

The vocation of animal nutritionists is to provide a large range of feed complements which meet expectations for feed manufacturers and breeders. Many methods for synthesizing different active compounds are thus being developed regularly and the resulting active compounds are brought on the market preferably in a form which may be easily added to feed rations.

Active compound feed intake into the protein metabolism is essential. Whereas carbohydrates are stored as glycogen and lipids as triglycerides, feed intake of active compounds in the animal protein metabolism, and notably amino acids, ensures the renewal of proteins of the organism (the compound is then active for in vivo protein synthesis) and the synthesis of absolutely necessary nitrogen-containing molecules (for example carnitine, creatine, or nucleotides).

Nevertheless, it is known that certain active compounds in the protein metabolism, and in particular amino acids, have organoleptic (i.e. generally perceivable by sense organs) properties which do not make them very attractive for ingestion. Thus, certain active compounds seem to cause reduction of ingestion in animals, which is notably expressed by perceivable deterioration of growth performances.

So many formulations and methods have attempted to solve this problem.

Notably, techniques for changing the functional groups of the active compound have been developed. These techniques attempt to change the actual active compound, in order to change its organoleptic properties. For example, this is the case of application EP 0 015 668 which relates to polyamino acids digestible by proteolytic enzymes present in the digestive systems of animals and humans, and which have a “less unpleasant” smell than that of the corresponding free amino acids.

Also, certain sweeteners have been used for suppressing the bitter aftertaste of certain active compounds. Notably, US Patent Application 2002/0193342 describes taste-masking compositions comprising at least one compound with an unpleasant taste (amino acid, protein hydrolysate, and/or protein component), in which the unpleasant taste of the compound is masked by adding sucralose (sucralose is a synthetic sweetener with a very strong sweetening power), in order to provide final acceptable compositions as regards taste. It is important to notice that the compositions are intended to be ingested by consumers, i.e. by persons who purchase the complement and subsequently have the possibility of returning to said complement.

Also, U.S. Pat. No. 4,175,121 describes a food additive based on a methionine hydroxy analog and which comprises a taste-masking agent, for example synthetic molasses known for its taste properties, this masking agent forming a coating adhering around the analog particles.

The feed complements contemplated by the present invention are intended for animals. They should therefore have certain characteristics which differ from complements intended for human beings.

Today, the problem is posed of providing further improvement to feed complements for animals and notably of increasing their intake by animals.

Therefore, the object of the present invention is to retain other ways as those described earlier for in particular improving appetence of the feed complements contemplated earlier.

Another object of the present invention is to improve the conditions of applying said complements for the human technician, at the same time.

The inventors unexpectedly realized that a low content or even an infinitesimal content of olfactory additive neutralizes the smell of the active compound within the feed complement, even so this active compound is present at high content within the complement.

Accordingly, the feed complement for animals, which is found in a divided solid form, or in a liquid form, according to the present invention, comprises at least one active compound, i.e. an amino acid, or an amino acid derivative, present at a content higher than or equal to 50% by weight of the feed complement, and is characterized is that it further comprises an olfactory additive, present at a content less than or equal to 3% by weight of the feed complement, said olfactory additive neutralizing the smell perceivable by humans, of said active compound.

Two types of amino acids are distinguished, essential amino acids which must be provided through feeding (histidine, isoleucine, leucine, lysine, methionine, threonine, tryptophan, valine) and unessential amino acids which the organism may synthesize (alanine, arginine, asparagine, aspartate, cysteine, glutamate, glycine, proline, serine, tyrosine). Such compounds are also called “nutritional additives”.

The term “amino acid derivatives” for example means salts, amides, alkyl and alcohol esters, and hydroxy analogs of amino acids and their own derivatives.

For information only, an amino acid derivative according to the present invention, 2-hydroxy-4-methylthiobutyric acid (hereafter called HMB or hydroxy analog of methionine), is known to be used as an analog of methionine for feeding livestock. It has the advantage of occurring in liquid form, which facilitates its use by feed producing companies.

These also may be methionine alkyl esters or the hydroxy analog of methionine, the alkyl chain of which for example contains 1 to 12 carbon atoms. The alkyl chain may be branched, linear or cyclic, for example isobutyl or tert-butyl.

The feed complements of the invention may also comprise several amino acids and/or amino acid derivatives, for example a mixture of methionine and its hydroxy analog.

It is certain that the choice of the amino acid or the amino acid derivative is related to its bioavailability in the blood. This bioavailability passes through determination of the active compound rate in the blood, relatively to the amount of active compound introduced into the ration of the animal. This determination takes into account the absorption rate in the intestine during the digestive transit, the passing of the food bolus into the different stomachs of polygastric animals and the transformation rate of the active compound if the latter is not directly assimilable by the organism (for example this is the case of the hydroxy analog of methionine).

The choice of the amino acid or the amino acid derivative is also related to the sought-after zoo technical effect on the animal. For example obtaining a beneficial effect on breeding like increasing the fertilization percentage may be desired. It may also be desired to increase the milk volume or the milk protein content in cattle. It may be desired to enhance growth of the animal; For example, methionine complementation is required in monogastric animals and this in order to ensure optimum performances.

Said amino acid or amino acid derivative is found in a form suitable for it to be added to the feed complement. Notably, it may be found naturally in a divided solid form, for example as granules, powder or as a liquid, or it may be in a suspension or solution. Also, said amino acid or amino acid derivative, may be found in a coated form, in order to avoid enzymatic destruction which occurs at a certain pH, for example in the paunch of ruminants and in the same time to allow controlled release of the amino acid or amino acid derivative in another portion of the digestive tract. The amino acid or amino acid derivative may also be found in the form of extended release or controlled release tablets.

According to an alternative of the present invention, said active compound is methionine and 2-hydroxy-4-methylthio-butyric acid.

The term “animal” more specifically means livestock and notably grazing animals (notably cattle raised for meat, milk, cheese, and leather; sheep raised for meat, wool, and cheese; goats; swine), rabbits, poultry (chicken, hens, turkeys, ducks, geese, and other fowls), aquatic animals (for example fishes, prawns, oysters and mussels), leisure animals and pets (notably horse, dog, cat). Cattle or bovines are a subfamily of bovidae, ruminant polygastric mammals, which comprise several important livestock species (milk breeds, meat breeds and mixed breeds).

An “olfactory additive” means any substance, compound or composition, intentionally added to another compound or composition which changes the proper olfactory characteristics of the compound or of the composition, to which it is added. This additive may include a nutritive value or not, and be consumed or not, as a food per se. The term “olfactory additive” also covers any mixture of substances or any fraction, for example obtained from a plant. For example, it may be a complex mixture of volatile compounds. Thus, “olfactory additive” refers to the sense of smell. Strictly, it only applies to what is perceived by the nose, as opposed to the term “taste” which refers to a property or character perceived by the sense of taste. However, said olfactory additive may also act on the taste, this at the same time as on the smell. The term “taste” or “flavour” which qualifies the property of a product of developing one or more of the four elementary flavours: acid, bitter, salted, sweet, by stimulating the gustatory system.

For the purposes of the present invention, the term “olfactory additive” covers scents in general, fragrant substances, fragrant preparations, perfumes from transformations, smoky odours or their mixtures. This may be a natural scent, derived in the majority of the cases from flower plants, or an artificial or synthetic scent which has the advantage of being less expensive. The olfactory additive according to the invention may also be formulated from one or more aromatic substances.

The term “aroma” is also covered under the generic term “olfactory additive”, provided that said aroma is characterized by olfactory properties, in addition to its gustatory properties. Hence, aromas having both olfactory and gustatory properties involving the sense of smell and of taste, respectively, are suitable for the present invention. Nevertheless, it needs to be specified that according to the present invention, the sought-after effect is the one which is related to the olfactory properties of the additive. Nevertheless, it is obvious that a compound which has gustatory properties in addition to olfactory properties cannot be excluded from the field of definition of the term “olfactory additive”.

The olfactory additive may be obtained by appropriate physical processes, or enzymatic or microbiological processes, from a material of plant or animal origin, either as is, or transformed for its consumption by traditional methods for preparing foodstuffs. It may also be obtained by chemical synthesis or isolated by chemical methods. Finally, this additive may be obtained by heating a mixture of ingredients which do not necessarily have olfactory properties individually.

Generally, the olfactory additive should moreover meet very strict constraints, and notably relatively to applicable regulations as regards toxicity levels because of its ingestion by the animal.

Different perceptions may characterize an olfactory additive according to the present invention. A distinction is generally made between the top note, the body or middle note, and the back note. The top note is the first perceived olfactory impression, which is due to the volatility of certain raw materials which compose it. It promotes immediate detection of the odor. For example this is the case of lavender perfume. The second perceived odors are the body notes which persist for several hours, for example the woody odor. Finally, the back notes are the third perceived odors. As an example, this is the case for vanilla and amber.

An olfactory additive according to the present invention may be selected by taking into account the succession of perceptions.

According to the present invention, the feed complement comprises at least one feed complement as defined earlier, present at a content higher than or equal to 50% by weight of the feed complement. Hence, the amino acid or the amino acid derivative, accounts for at least the half of the composition by weight of the feed complement. The feed complement is therefore mainly based on an amino acid or an amino acid derivative.

Also, according to the present invention, the feed complement comprises an olfactory additive present at a content higher than or equal to 3% by weight of the feed complement.

According to an alternative of the present invention, the active compound is present within the feed complement at a content higher than or equal to 90% by weight of said complement. According to another alternative of the present invention, said olfactory additive is present within the feed complement at a content lower than or equal to 1% by weight of said complement, and preferably at a content between 0.01% and 1%, or between 0.03% and 0.1%, by weight of said complement.

In addition, the present invention is characterized in that said olfactory additive neutralizes the odor of said active compound. “Neutralizing” means the action of cancelling out or suppressing the odor of the active compound, perceivable by the animal and/or the human. According to another embodiment of the present invention, said olfactory additive masks the odor of the active compound. “Masking” means the action of not only cancelling the odor of the active compound, but also substituting for the latter another pleasant or acceptable odor for the animal and/or for the human. Therefore the verb “to mask” is at a higher level, relatively to the verb “to neutralize”. According to the present invention, the additive neutralizes and then possibly masks the unpleasant odor of the active compound.

In addition, the olfactory additive may impart to said complement an odor distinct from the odor of said same complement without said olfactory additive, and this in a way perceivable by the animal.

Perception of the olfactory additive in animals may be established by significantly or discriminately differentiating a behavior of zoo technical interest, for example appetence, with regards to the feed complement without the olfactory additive and to the same complement with said olfactory additive, respectively.

Such a perception characteristic in animals for example may be demonstrated by applying a consumption test, consisting of comparing consumption of feeds containing said different complements, and of feeds which do not contain any of them.

Hence, generally, the goal of the test is to compare consumption by an animal population, when this animal population has the choice between feeds containing the active compound to which the olfactory additive is added, and feeds containing the amino acid or the amino acid derivative without the olfactory additive, the latter for example being used for increasing appetence for the feed. “Appetence” means the desire to absorb the feed in response to perception of the organoleptic features of said feed.

The consumption test may therefore be used for evaluating the effectiveness of feed complements.

The test should meet requirements of the European Directive as of 24.11.86 relative to the protection of animals used for experimental purposes or other scientific purposes.

Each feed complement, either including or not an olfactory additive, is called a test item. In a first phase, the followed experimental plan, i.e. the tested animal species, the numbers in each group, the followed diet, the duration of the diet and the dosage in each test item are defined. It is also necessary to select a basic feed to which are added different test items to be tested. This basic feed for example may comprise maize, wheat, peas, and soya. Controls may also be included in the study. Such a test is for example applied in Examples 2 to 4.

The feed complement according to the invention comprises an active compound, i.e. an amino acid or an amino acid derivative, at a content higher than or equal to 50% by weight of the complement, and an olfactory additive as defined earlier and present at a content less than or equal to 3% by weight of the complement. The feed complement of the present invention additionally is likely to comprise other ingredients. Among the latter, binders and diluents, for example water, may be mentioned for example. It may also comprise several amino acids and/or derivatives of amino acids.

As explained above, the amino acid or the amino acid derivative is selected according to the sought-after zoo technical effect (growth, milk production . . . ). Also, the global composition of the feed complement according to the invention depends on the technical effect of said olfactory additive. Preferentially, said olfactory additive increases appetence for said complement relatively to the same complement but without said olfactory additive.

The feed complements of the present invention are intended for animals; the odor of the complement to which the additive is added should significantly or discriminately be perceivable by the animal, for which the ration is intended, and this relatively to the same complement but without said olfactory additive.

In addition, the feed complements according to the invention are notably handled by all the persons applying the additive during manufacturing of the complements or feeds, and it is advantageous if the odor of the complement to which an olfactory additive is added, is also perceivable by humans. Hence, advantageously, the complement according to the invention comprises an olfactory additive which neutralizes the odor of the active compound in a way perceivable by humans. In addition, this olfactory additive imparts to said complement, an odor perceivable by humans and distinct from the odor of said same complement without said olfactory additive, i.e., either suppression or neutralization of the odor attached to the active compound or characteristic thereof, or substitution for said odor of a new or other odor, pleasant or acceptable to humans.

Said feed complement is obtained by mixing these different constituents. Said olfactory additive and the active compound are therefore thoroughly mixed. Both of these compounds are, in no way, separated by any suitable barrier. The different fragrant molecules are in contact with each other.

Hence, according to an alternative of the present invention, the active compound and the olfactory additive are mixed and in contact with each other.

The present invention also relates to a feed for animals, notably of the feed ration type, comprising the feed complement as defined above.

The present invention further relates to a method for feeding a bred animal characterized in that a feed complement as defined above is added to the feed ration of said animal.

The present invention finally relates to the use of the feed complement as defined above for feeding a bred animal and possibly for improving its zoo technical performances.

With the Examples below and the figures, it is possible to demonstrate certain advantages and features of the present invention.

FIG. I is obtained from data of Table I. It illustrates the effect of the olfactory additive on the odor of the active compound no. 1 (methionine hydroxy analog).

FIG. II is obtained from data of Table II. It illustrates the effect of the olfactory additive on the odor of the active compound no. 2 (methionine hydroxy analog isopropyl ester).

### EXAMPLE 1

The goal is to determine the minimum concentrations of an olfactory additive with which the sulfur odor of two active compounds may be masked.

The selected olfactory additive in a composition with a back note notably of the vanilla type and with fruit notes (pineapple, . . . ). The hydroxy analog of methionine (active compound no. 1) is marketed by Adisseo, under the trade name AT88. Methionine hydroxy analog isopropyl ester (active compound no. 2) is marketed by Adisseo under the trade name MetaSmart

A range of solutions of active compound no. 1 and of active compound no. 2 is prepared, containing variable additive concentrations: 100 g of active compound no. 1 or active compound no. 2 is poured into 6 glass 125 ml flasks. In 5 of the 6 flasks, the following amounts of olfactory additive are added: 0.010 g (i.e. a solution at about 0.01% by weight of olfactory additive); 0.030 g (i.e. a solution at about 0.03% by weight of olfactory additive); 0.1 g (i.e a solution at about 0.1% by weight of olfactory additive); 0.3 g (i.e. a solution at about 0.3% by weight of olfactory additive) and 1 g (i.e. a solution at about 1% by weight of olfactory additive). The flasks are then stoppered and manually shaken.

Assessment of the odor perceived by humans, of the aforementioned solutions is performed in the following way: the pleasant or unpleasant character of the odor given off by the product (an active compound with or without any olfactory additive) is assessed by a panel of noses formed with 12 persons. Each person gives his/her perception according to three criteria:
unpleasant
acceptable
pleasant.

The 6 flasks of mixture are placed on a lab bench, under an operating fume hood. The flasks are each opened in turn and the tester dips a strip of paper into the mixture, over 1 cm. The paper is carried up to the height of the nose and the person from the panel smells the paper rapidly and then gives his/her assessment according to the three sensations. One starts with the control flask without any olfactory additive and then one continues with mixtures with increasing concentrations of olfactory additive. As soon as all the answers have been obtained with the panel of noses, the flasks are again stoppered and placed in an oven at 42° C. for 4 weeks. At the end of the lapse of time, the products are brought back to room temperature, and a new assessment of the odor is performed by the same panel of noses.

The detailed results from the consultation are shown for each type of product: Tables I and II.

A. Assessment Tables

TABLE I
Assessment of the odor of the mixture, active compound no. 1 and
olfactory at different concentrations.

| | olf. add./active | | olf. add./active | | olf. add./active | | olf. add./active | | olf. add./active | |
|---|---|---|---|---|---|---|---|---|---|---|
| | compound no. 1 | | compound no. 1 | | compound no. 1 | | compound no. 1 | | compound no. 1 | |
| | 0.106 g/kg | | 0.302 g/kg | | 1.001 g/kg | | 3.02 g/kg | | 9.97 g/kg | |
| | (0.1 g/kg) | | (0.3 g/kg) | | (1 g/kg) | | (3 g/kg) | | (10 g/kg) | |
| | Room | After 1 month | Room | After 1 month | Room | After 1 month | Room | After 1 month | Room | After 1 month |
| | Temp. | aging at 40° C. | temp. | aging at 40° C. | temp. | aging at 40° C. | temp. | aging at 40° C. | | |
| Panel 1 | − | − | − | − | − | + | + | + | − | − |
| Panel 2 | − | + | + | − | − | − | − | − | − | − |
| Panel 3 | − | + | − | − | + | − | − | − | − | − |
| Panel 4 | − | + | + | + | + | + | − | + | − | − |
| Panel 5 | − | − | − | − | + | + | + | + | ++ | − |
| Panel 6 | − | − | − | − | − | − | − | + | + | − |
| Panel 7 | − | − | − | − | − | + | − | − | − | − |
| Panel 8 | − | − | − | − | − | − | − | − | − | − |
| Panel 9 | − | + | − | − | − | − | − | − | + | − |
| Panel 10 | − | − | − | − | + | + | + | − | − | − |
| Panel 11 | − | − | − | + | − | − | + | − | + | − |
| Panel 12 | − | − | − | − | + | + | + | − | − | − |
| Acceptable % | 0 | 33 | 17 | 17 | 42 | 50 | 42 | 33 | 33 | 0 |

++: pleasant
+: acceptable
−: unpleasant

TABLE II
Assessment of the odor of the mixture, active compound no. 2 and
olfactory additive at different concentrations

| | olf. add./active | | olf. add./active | | olf. add./active | | olf. add./active | | olf. add./active | |
|---|---|---|---|---|---|---|---|---|---|---|
| | compound no. 2 | | compound no. 2 | | compound no. 2 | | compound no. 2 | | compound no. 2 | |
| | 0.12 g/kg | | 0,34 g/kg | | 1.01 g/kg | | 3 g/kg | | 10.03 g/kg | |
| | (0.1 g/kg) | | (0,3 g/kg) | | (1 g/kg) | | (3 g/kg) | | (10 g/kg) | |
| | Room | After 1 month | Room | After 1 month | Room | After 1 month | Room | After 1 month | Room | After 1 month |
| | Temp. | aging at 40° C. | temp. | aging at 40° C. | temp. | aging at 40° C. | temp. | aging at 40° C. | | |
| Panel 1 | − | − | − | − | + | + | + | + | − | − |
| Panel 2 | − | − | − | + | + | − | − | − | − | − |
| Panel 3 | − | − | − | + | − | + | + | + | − | − |
| Panel 4 | − | − | − | − | + | + | + | + | − | − |
| Panel 5 | − | − | − | − | − | − | + | + | + | + |
| Panle 6 | − | − | − | − | + | + | + | + | ++ | + |
| Panel 7 | − | − | − | − | − | − | − | − | − | + |
| Panel 8 | − | − | − | − | − | − | + | + | + | + |
| Panel 9 | − | − | − | − | − | − | − | − | − | + |
| Panel 10 | − | − | − | − | − | + | + | − | − | − |
| Panel 11 | − | − | − | + | − | + | − | − | + | + |
| Panel 12 | − | − | − | − | − | + | + | + | + | + |
| Acceptable % | 0 | 0 | 0 | 25 | 33 | 58 | 66 | 58 | 41 | 58 |

++: pleasant
+: acceptable
−: unpleasant

B. Response curves

FIGS. I and II are obtained from the data of Tables I and II, respectively, illustrating the acceptability rate for each mixture, by averaging the obtained responses.

NB: as response ++ (i.e. pleasant) is only obtained once per mixture type, it is accounted for in the + responses (i.e. acceptable).

As it appears upon reading FIG. I, adding the olfactoring additive has a notable effect on the perception of the odor of active compound no. 1.

As soon as the concentration of olfactory additive is 0.3 g/kg, 17% of the panel find the odor of the mixture acceptable.

But, regardless of the incorporation dosage, there is no majority for finding that the odor is acceptable (from 1 g/kg to 10 g/kg).

In the comments from the members of the panel, it is noted that beyond 3 g/kg it is the odor of the additive which predominates without however making the mixture pleasant. Addition of 1 g per kg of active compound no. 1 may therefore be recommended in order to optimize the neutralization of the bad smell of the active compound no. 1 alone.

A different response curve is found after aging solutions supplemented with olfactory additive, for 1 month at 40° C. This time, a neutralizing effect is perceived from 0.1 g of aroma per kg of active compound no. 1 onwards since 33% of the panel this time find the odor of the product acceptable.

The acceptability majority is reached from 1 g/kg.

And then at 10 g, the inverse effect is produced, the too strong odor of the olfactory additive dominates significantly.

After aging there is an improvement in the acceptability of the mixture, no doubt because bad-smelling volatile compounds from the active compound no. 1 have been decomposed. The olfactory additive is very stable under these conditions. The recommandation for 1 g/kg remains unchanged.

As is shown by FIG. II, adding the olfactory additive has a notable effect on the perception of the odor of active compound no. 2. From an addition of 0.3 g/kg, of active compound no. 2 onwards, 25% of the panel find the odor of the product acceptable.

The optimum for the acceptability response (2 persons out of 3) is reached for an addition of 3 g/kg.

As the acceptability % decreases for the 10 g/kg dose (too much olfactory additive gives an unpleasant smell).

Therefore an addition between 1 and 3 g is recommended so that the neutralizing effect is effective.

The same effect of aging on the effectiveness of the neutralizing agent in the sense of improvement, is reported.

After 1 month at 40° C., 25% of the panel find the odor of the mixture acceptable with addition of 0.3 g/kg (versus 0% with the fresh product).

The majority of the panel (58%) find the mixture acceptable with an addition of 1 g/kg.

At 3 g, there is no difference in perception and at 10 g, there is an improvement in acceptability between t=0 and t=1 month.

From this, it is concluded that the olfactory additive does not undergo any degradation during a storage period of one month at 40° C. and that bad-smelling volatile compounds of active compound no. 2 may also be transformed.

### EXAMPLE 2

The goal of the test is to compare the consumption by 7-day chickens when they have the choice between feeds containing methionine hydroxyl analog (test item no. 1) or methionine hydroxyl analog to which 1 g/kg of olfactory additive is added (test item no. 2), for a same supply of methionine, with comparisons per pair and depending on the methionine source provided by the feed from D0 to D6 (test items no. 1 or 2).

The test item no. 2 therefore comprises 99.9% by weight of methionine hydroxy analog and 0.1% by weight of olfactory additive.

The test items are incorporated into a mixture of maize and soya, which is used as basic feed. The consumption measurements are performed over 24 hours.

The experimental plan is the following:

| Diets | A | B | C | D |
|---|---|---|---|---|
| Feeding from D0 to D6 | Test item no. 1 | | Test item no. 2 | |
| Feeding from D7 to D8 | Test item | Test item | Test item | Test item |
| | no. 1 | no. 2 | no. 1 | no. 2 |
| Doses (%) | 0.17 | 0.17 | 0.17 | 0.17 |

| | | |
|---|---|---|
| Numbers | 100 | 100 |

200 male ROSS stock chicks are selected and placed in cages fitted out with a water bowl and a feeder with a capacity of about 0.3 kg. 10 chicks are placed per cage. The animals are separated into two groups, receiving the test item no. 1 or 2, during the experimental pre-period (i.e. from D0 to D6).

During the experimental phase (i.e. from D7 to D8), the animals have the choice between the feed they had the first 6 days, and the other feed, each of these feeds being located in two different bowl feeders of the same cage. Feeding is ad libitum with checking of the consumptions at T0+1 hour, T0+2 hours, T0+4 hours, T0+6 hours, T0+8 hours, T0+10 hours and T0+24 hours. Moreover, at each check, the two bowl feeders are interchanged in order to prevent the animals from being accustomed to the positioning of the bowl feeders.

Results:

| | Feeding from | | | | |
|---|---|---|---|---|---|
| | D0 to D6 | | | | |
| | → | Test item no. 1 | | Test item no. 2 | |
| | Feeding from | Test | Test | | |
| | D7 to D8 | item | item | Test item | Test item |
| Consumption | → | no. 1 | no. 2 | no. 1 | no. 2 |
| (g) | Diets → | A | B | C | D |
| T0 +g0 1 h | Average | 13.4a | 17.7bd | 14.6ab | 18.7cd |
| | Stand. dev. | 3.81 | 2.67 | 5.76 | 3.37 |
| | CV | 28.4 | 15.1 | 39.4 | 18.01 |
| | Delta (%) | | 32.1 | | 28.1 |
| T0 +g0 2 h | Average | 22.9a | 27.1ab | 23.9a | 30.6b |
| | Stand. dev. | 4.68 | 4.33 | 6.44 | 4.27 |
| | CV | 20.4 | 16.0 | 26.9 | 13.97 |
| | Delta (%) | | 18.3 | | 28.0 |
| T0 +g0 4 h | Average | 36.1a | 49.3b | 40.4a | 49.3b |
| | Stand. dev. | 6.76 | 4.55 | 11.78 | 7.35 |
| | CV | 18.7 | 9.2 | 29.2 | 18.28 |
| | Delta (%) | | 36.6 | | 22.0 |
| T0 +g0 6 h | Average | 52.5a | 65.8b | 56.5a | 67.7b |
| | Stand. dev. | 6.24 | 6.37 | 12.07 | 12.37 |
| | CV | 11.9 | 9.7 | 21.4 | 18.28 |
| | Delta (%) | | 25.3 | | 19.8 |
| T0 +g0 8 h | Average | 66.2a | 89.4b | 71.7a | 89.2b |
| | Stand. dev. | 7.86 | 7.73 | 15.42 | 11.76 |
| | CV | 11.9 | 8.7 | 21.5 | 13.19 |
| | Delta (%) | | 35.0 | | 24.4 |
| T0 +g0 10 h | Average | 83.8a | 109.6b | 88.1a | 109.7b |
| | Stand. dev. | 9.87 | 11.12 | 15.13 | 13.92 |
| | CV | 11.8 | 10.1 | 17.2 | 12.69 |
| | Delta (%) | | 30.8 | | 24.5 |
| T0 +g0 24 h | Average | 160.8a | 209.6b | 165.5a | 212.8b |
| | Stand. dev. | 14.79 | 17.85 | 26.50 | 19.18 |
| | CV | 9.2 | 8.5 | 16.0 | 9.01 |
| | Delta (%) | | 30.3 | | 28.6 |

NB: The averages followed by the same letters are not significantly different at the 5% threshold.

The illustrated consumption is the consumption per cage, i.e. for 10 chicks. This consumption satisfies the following formula: (weight of the feeder at the end of the period)−(weight of the feeder at the beginning of the period).

The averages are performed over 10 cages per diet choice. As soon as T0+1 hour, it is reported that test item no. 2 is preferred to test item no. 1. For the first series (diets A and B), i.e., for chicks which received pre-experimental feeding based on test item no. 1, the consumption of test item no. 2 is 17.7 g (diet B) versus the consumption of test item no. 1 of 13.4 g (diet A). Thus, the chicks consumed an extra 4.3 g of test item no. 2 relatively to test item no. 1, i.e., 32% more. Also, for the second series (diets C and D), i.e. for chicks which received pre-experimental feeding based on test item no. 2, the chickens consumed 18.7 g of test item no. 2 (diet D) versus 14.6 g of test item no. 1 (diet C). Thus, the chickens consumed an extra 4.1 g of test item no. 2 relatively to test item no. 1, i.e. 28.1% more.

The checking of the consumptions at different times shows that at each time, test item no. 2 is preferred to test item no. 1.

The variance and the standard deviation are indicators of dispersion. They show values which are not very dispersed around the average, and so globally homogeneous series. Thus, comparison of the diets shows that the animals prefer the feed containing test item no. 2 to test item no. 1.

Furthermore, it is interesting to report that the animals prefer test item no. 2 to test item no. 1 over a 24 hour consumption when the feed from D0 to D6 contains test item no. 2.

It should be fully noted that a low olfactory additive content, i.e., 0.1% by weight in test item no. 2, leads to a significant preference of the animals in terms of consumption. The olfactory additive neutralizes the odor of the methionine hydroxy analog, while the latter is present at a weight content of 99.9%.

### EXAMPLE 3

The goal of the test is to compare food consumption of 6 day turkey poults when they have the choice between feeds containing methionine hydroxy analog (test item no. 1), methionine hydroxy analog to which 0.5 g/kg of olfactory additive is added (test item no. 2) or methionine (test item no. 3).

Test item no. 2 therefore comprises 0.05% of olfactory additive for 99.95% of methionine hydroxyl-analog.

The test items are incorporated into a mixture of maize and soya, which is used as basic feed.

The experimental plan is the following:

| Feeding from D0 to D6 | | | | | | |
|---|---|---|---|---|---|---|
| (8.00 am) | Identical for all the animals | | | | | |
| Feeding on D6 (from 8 am | A | | B | | C | |
| to 5 pm), the animals have | Test | Test | Test | Test | Test | Test |
| choice between: | item | item | item | item | item | item |
| | no. 3 | no. 31 | no. 3 | no. 2 | no. 1 | no. 2 |
| Doses (%) | 0.20 | 0.23 | 0.20 | 0.23 | 0.23 | 0.23 |

| | | | |
|---|---|---|---|
| Numbers | 60 | 60 | 60 |

150 turkey poults of stock BUT 9 are selected and placed in cages fitted out with a water bowl and two feeders with a capacity of about 0.3 kg. 5 turkey poults are placed per cage.

The animals receive during the pre-experimental period (i.e. from D0to D6, 8.00am), an identical standard starting feed. During the experimental phase (i.e. D6 from 8am to 5pm), the animals are separated into three groups 10 A, B and C. For each group and each cage of this group, the animals have the choice between two test items. For example the animals of group A may choose between test item no. 3 and test item no. 1. Feeding is ad libitum with checking of consumption at T0+1 h, T0+3 h, T0+5 h, T0 +7 h and T0+9 h. Furthermore, at each measuring time, the two feeders are interchanged in order to prevent the animals from being accustomed to the positioning of the feeders.

The incorporation dosages between items no. 1, no. 2 and no. 3 are different because of the difference in supply of active compound between test item no. 3, as a powder, and test items no. 1 and no. 2 as a liquid, which contain 88% of active material. The correspondence factor used between test item no. 3 and liquid test items no. 1 and no. 2 is 1.13 (0.2 ×1.13 =0.23).

Results:

| | | A | | B | | C | |
|---|---|---|---|---|---|---|---|
| | | Test item | Test item | Test item | Test item | Test item | Test item |
| Feeding D6 → | | no. 3 | no. 1 | no. 3 | no. 2 | no. 1 | no. 2 |
| Dose (%) | | 0.2 | 0.23 | 0.2 | 0.23 | 0.23 | 0.23 |
| T0 + 1 h | Average | 6.8 | 9.0 | 9.1 | 9.1 | 0.23 | 0.23 |
| | Stand. dev. | 2.20 | 1.94 | 2.38 | 2.92 | 2.53 | 2.31 |
| | CV | 32.4 | 21.6 | 33.5 | 32.1 | 32.4 | 27.9 |
| | Delta (%) | | 32.4 | | 28.2 | | 6.4 |
| T0 + 3 h | Average | 15.5 | 16.4 | 14.9 | 18.6 | 15.0 | 17.2 |
| | Stand. dev. | 2.17 | 2.63 | 3.31 | 4.62 | 3.56 | 2.62 |
| | CV | 14.1 | 16.1 | 22.2 | 24.9 | 23.7 | 15.2 |
| | Delta (%) | | 6.5 | | 24.3 | | 14.7 |
| T0 + 5 h | Average | 23.3 | 23.8 | 22.6 | 28.1 | 21.6 | 26.1 |
| | Stand. dev. | 3.06 | 3.88 | 4.90 | 6.64 | 4.40 | 3.84 |
| | CV | 13.1 | 16.3 | 21.7 | 23.6 | 20.4 | 14.7 |
| | Delta (%) | | 2.1 | | 24.3 | | 20.8 |
| T0 + 7 h | Average | 30.3 | 29.6 | 30.0 | 34.9 | 27.4 | 32.5 |
| | Stand. dev. | 3.50 | 3.06 | 5.19 | 7.50 | 5.10 | 4.99 |
| | CV | 11.5 | 10.3 | 17.3 | 21.5 | 18.6 | 15.4 |
| | Delta (%) | | −2.3 | | 16.3 | | 18.6 |
| T0 + 9 h | Average | 37.7 | 37.4 | 36.8a | 43.2b | 34.4a | 40.4b |
| | Stand. dev. | 4.76 | 2.99 | 7.19 | 8.98 | 3.89 | 5.38 |
| | CV | 12.6 | 8.0 | 19.5 | 20.8 | 11.3 | 13.3 |
| | Delta (%) | | −0.8 | | 17.4 | | 17.4 |

The illustrated consumption is the consumption per cage, i.e. for 5 turkey poults. This consumption satisfies the following formula: (weight of the feeder at the end of the period)−(weight of the feeder at the beginning of the period). Averages are performed for each group over 12 cages.

As soon as T0+1 hour, it is reported that test item no. 2 is preferred to test item no. 3 (group B) and to test item no. 1 (group C). These differences increase during the different checks.

For example, at T0+5 hours, whereas the difference between the consumption of test item no. 1 and that of test item no. 3 in group A is not significant, group B has consumed an average of 28.1 g of test item no. 2 versus 22.6 g of test item no. 3. Thus, the turkey poults have consumed an extra 24% of test item no. 2 relatively to test item no. 3. Also, group C has consumed an average of 26.1 g of test item no. 2 versus 21.6 g of test item no. 1. Thus, the turkey poults have consumed an extra 21% of test item no. 2 relatively to test item no. 1.

At T0+9 h, the averages are significantly different at the 5% threshold. There thus appears a preference (+17% more consumption) of the animals for the feed containing item no. 2 (hydroxy analog+olfactory additive) when it is freely chosen, either with item no. 1 (group C) or with item no. 3 (group B). Furthermore, the consumption differences are not significant in the case of the choice between test item no. 1 and test item no. 3 (group A).

Finally, adding the olfactory additive to methionine hydroxyl-analog (test item no. 2) causes a very strong preference (p=0.009) of the animals relatively to methionine hydroxyl-analog alone (test item no. 1).

### EXAMPLE 4

The goal of the test is to compare feed consumption of 7-8 kg post-weaning piglets when they have the choice between feeds containing methionine hydroxy analog (test item no. 1) or methionine hydroxy analog to which 0.5 g/kg of olfactory additive is added (test item no. 2).

Test item no. 2 therefore comprises 0.05% of olfactory additive for 99.95% of methionine hydroxy analog.

The test items are incorporated into a basic feed based on maize and soya and containing 5% of beet molasses.

The experimental plan is the following:

| Feeding from D0 to D7 | Identical | |
|---|---|---|
| (8.00 am) | | |
| Feeding on D7, | Test item no. 1 | Test item no. 2 |
| The animals have the choice between: | | |
| Doses (%) | 0.24 | 0.24 |

| | |
|---|---|
| Numbers | 4 |

Four piglets are selected and placed in individual cages comprising two feeders and a pipette which allows watering.

For 7 days, the animals receive a basic feed comprising maize and soya and not containing any additional methionine source.

On the morning of the 7^{th} th day after weaning, the animals have the choice between test item no. 1 and test item no. 2, each of these test items being located in two different feeders of the same cage. Consumption measurements are carried out at T0+3 hours, T0+6 hours ; T0+9 hours and T0+24 hours at the first contact. Furthermore, at each measuring time, both feeders are interchanged, in order to prevent any habit due to the configuration of the cage.

Results:

| | | |
|---|---|---|
| Consumption (g) | Test item no. 1 | Test item no. 2 |
| At T0 + 24 h | | |
| Average | 163.9a | 228.8b |
| Standard Deviation | 57.8 | 97.8 |
| (SEM) | | |

The results of the consumptions appear to be very variable at the early hours with variation coefficients larger than 100%. However, after 24 hours of choice, the variability of the measured consumptions, although high, is acceptable. The obtained variations are due to the low number of repetitions (only 4) and to the actual animal model which, unlike the chicks, does not feed itself regularly along the nycthemer but more in the form of meals.

The illustrated consumption is the consumption per cage, i.e. for one piglet. The averages are performed over 4 cages.

A trend is reported, according to which test item no. 2 is preferred to test item no. 1. Indeed, the consumption of test item no. 1 is an average of 163.9 g versus a consumption of test item no. 2 of an average of 228.8 g. Thus, the piglets have consumed on the average, an extra 64.9 g of test item no. 2 relatively to test item no. 1; i.e., 40% more.

By adding the olfactory additive (test item no. 2) it is possible to increase its acceptability during a free choice for the piglet.

1. Feed complement for animals, as a divided solid or as a liquid, comprising at least one active compound, i.e., an amino acid or an amino acid derivative, present at a content higher than or equal to 50% by weight of the feed complement, characterized in that it further comprises an olfactory additive, present at a content less than or equal to 3% by weight of the feed complement, said olfactory additive neutralizing the odor, perceivable by humans, of said active compound.

2. The feed complement according to claim 1, wherein the active compound and the olfactory additive are mixed and in contact with each other.

3. The feed complement according to claim 1, wherein the active compound is present at a content higher than or equal to 90% by weight of said complement.

4. The feed complement according to claim 1, wherein said olfactory additive is present at a content less than or equal to 1% by weight of said complement.

5. The feed complement according to claim 4, characterized in that the olfactory additive is present at a content between 0.01% and 1% or between 0.03% and 0.1%, by weight of said complement.

6. The feed complement according to claim 1, characterized in that said active compound is methionine and 2-hydroxy-4-methylthio-butyric acid.

7. An animal feed, notably a feed ration, comprising the feed complement according to claim 1.

8. A method for feeding a bred animal, characterized in that a complement according to claim 1 is added to the feed ration of said animal.

9-10. (canceled)
